(19) United States
(12) Patent Application Publication
(10) Pub. No.: US 2003/0126010 A1
(43) Pub. Date: Jul. 3, 2003

(54) Method and system for generating and deploying a market research tool

(76) Inventor: Ileana Barns-Slavin, Wilton, CT (US)

Correspondence Address: Paul A. Levitsky, 107 Grist Mill Road, Monroe, CT, 06468, US

(21) Appl. No.: 10/291,964

(22) Filed: Nov. 12, 2002

Related U.S. Application Data
(60) Provisional application No. 60/348,357, filed on Nov. 9, 2001.

(51) Int. Cl. G06F 17/60

(52) U.S. Cl. 705/10

(57) ABSTRACT

The invention is a method and system for generating and deploying a research questionnaire in an integrated research program. The method begins with the initiation of a generation program for generating the questionnaire by defining its characteristics and associated reports. The generation program is interoperably linked with at least one database, for porting data to populate fields of the market research questionnaire. Upon completion, the system deploys the questionnaire in accordance with several options. The flexibility of the underlying system is demonstrated by its ability to let multiple respondents, in multiple locations, respond to the questionnaire while immediately capturing relevant data and generating reports based on those responses. The reporting module, can be merged with internal reports or can be transmitted to a remote location, downloaded for printing, or re-integrated. Data can be further merged with the responses, the original questionnaire, or even with the available reporting formats.

### RELATED APPLICATIONS

This application claims priority to U.S. Provisional Patent Application Serial No. 60/348,357 filed on Nov. 9, 2001.

### FIELD OF THE INVENTION

The present invention relates generally to the field of market research and questionnaire and reporting module development within a data processing environment; and, more specifically, to the field of integrated research systems where a questionnaire to be deployed to a set of respondents can be delivered in varied electronic forms while being fully flexible in its structure and content. The utilization of the flexible structure allows for more responsive report structures that can be fully integrated with the data source.

### BACKGROUND OF THE INVENTION

As computers have proliferated and gone from the unique to the commonplace, so too have the other tools of the office environment. Calendars once kept on paper blotters are now resident in electronic organizers. The data storage barrier gets pushed further and further back; and, communication is constant and relatively consistent. These achievements have driven other achievements.

Traditional methods of gathering knowledge to support business activities, has shifted as well. Market research, once done with pencils, calculators and paper questionnaires, has given way to computers, databases and instant reporting. The ability to convert questionnaires to a format that can be transmitted via e-mail or internet links has allowed data to be collected quickly and across greater distances. The more efficient gathering of data has fostered better methods of reporting and interpreting the collected data. One such improvement is disclosed in U.S. Pat. No. 5,842,195 for a METHOD AND APPARATUS FOR PREPARATION OF A DATABASE DOCUMENT IN A LOCAL PROCESSING APPARATUS AND LOADING OF THE DATABASE DOCUMENT WITH DATA FROM REMOTE SOURCES issued Nov. 24, 1998 to Peters et al. (hereinafter referred to as Peters 1). Peters 1 discloses a system for obtaining information from a plurality of nodes wherein a survey author could input data and a survey authoring mechanism would construct a questionnaire. The resulting survey could be transmitted to a plurality of respondent users. The information supplied by the respondents would be collected and tabulated. A further improvement to the art is found in U.S. Pat. No. 5,893,098 for a SYSTEM AND METHOD FOR OBTAINING AND COLLATING SURVEY INFORMATION FROM A PLURALITY OF COMPUTER USERS issued Apr. 6, 1999 to Peters et al. (hereinafter referred to as Peters 2). Both Peters 1 and Peters 2 were particularly concerned with the problem of collating questionnaire responses received from a plurality of users. A drawback to both Peters 1 and Peters 2, however, was the inability of those systems to receive a response directly back, integrate data on the fly, and then reformat the reporting structure automatically or as based upon certain parameters.

The ability of firms to collect information from their questionnaires has also seen improvement and optimization. U.S. Pat. No. 6,332,129 for a METHOD AND SYSTEM FOR UTILIZING A PSYCHOGRAPHIC QUESTIONNAIRE IN A BUYER-DRIVEN COMMERCE SYSTEM, issued Dec. 18, 2001 to Walker et al. (hereinafter referred to as Walker) is a good example of the Priceline.com integration model at work. The questionnaire of Walker is used to gather information based upon which the underlying business transaction may be changed. The strength of Walker is in the ability to adapt to the business climate. The one drawback, however, is that the model is offer/acceptance driven and therefore is not fluid in its application.

Based on the aforementioned needs in the art, a desired aspect of the present invention is to provide a means of integrating market research tools so that survey building tools, data structures and databases, communications links with respondents, and report generators become more interoperable and thus drive each other's efficiency.

It is a further desired aspect of the present invention to increase the ability of a research questionnaire to be deployed to potential respondents. The ease of deployment to be enhanced by flexible questionnaire structuring, availability on varied media and via varied forms of delivery. Additionally, it is a further aspect of the present invention that a response to a questionnaire be directly channeled back to the reports generator for integration and reformatting.

### SUMMARY OF THE INVENTION

The invention is a method and system for generating and deploying a market research questionnaire (MRQ) in an integrated research program. The inventive method comprises a number of steps that begin with initiating a generation program for generating the market research questionnaire by defining its characteristics and reports. The defining step further comprises the step of assigning a file name for the market research questionnaire as well as allowing for a description of the file. The generation program resides in a data processing system and is interoperably linked with at least one database which can be internal or external to the system, for porting data from the database to the generation program so that one or more data fields of the market research questionnaire are populated by demographic or structural data or data that defines a particular respondent or group of respondents.

An important step of the subject method is the entering of a set of questions and a set of corresponding answer choices into the data fields of the market research questionnaire. While entering the question and answer information, the system user is able to select a navigation path for modifying the generation program. Upon completion of the questionnaire, the system deploys the questionnaire in accordance with several options available to the user. The deploying step can be accomplished in one of several ways or in a combination of ways; these include: generating ASP files within the generation program; establishing an e-mail link from the questionnaire or from one or more reports through the generation program.

The flexibility of the underlying system is demonstrated by its ability to let multiple respondents, in multiple locations, respond to the questionnaire while immediately capturing relevant data and generating reports based on those responses. The reports, in turn, can be merged with reports assembled internally to the system or can be transmitted to a remote location or simply downloaded for printing. Data can be further merged with the responses, the original questionnaire, or even with the available reporting formats.

The questionnaire formatting is limited only by the imagination of the system user. There are a number of question types that can be input. The various types can be employed singly, in varied combinations, or not at all. The question formats include: questions capable of being answered with a “yes” or “no” response; questions of a multiple-choice type wherein a response to the multiple-choice question is chosen from a plurality of possible responses; open-ended type questions where a response to the open-ended question is compared to a field of possible responses to determine whether or not the response to the open-ended question is to be categorized; a single choice question; and, a group choice. In addition, there are a number of formats that are suggested by the department, policies, or industry requirements that allow unique question formation.

The system for generating and deploying the market research tool, or questionnaire, comprises a number of key elements that include a data processing system; a questionnaire generating program capable of being run on the data processing system; and, first data storage means, for storing data which can be downloaded to the questionnaire generating program by request from the program. The system will effectively accept data input from a variety of input means such as keyboards, scanners, file transfer, etc. The data input means for inputting data to the questionnaire generating program is generally utilized in response to queries from the questionnaire generating program. Additionally, the system utilizes at least three different means for deploying the questionnaire to respondents; these include: ASP file generation for web site communication; e-mail links; and, simple print-ready deployment.

The reporting module of the research program is capable of producing a fully integrated report as well as breaking out additional reports that can be printed, transmitted or further integrated.

### BRIEF DESCRIPTION OF THE DRAWINGS

FIG. 1 is a diagram of the system of the present invention showing the interoperability relationship of each of the high-level components of the system.

FIG. 2 is a diagram of the program relationships for each of the high-level routines and data sources for the questionnaire generating system of the present invention.

FIG. 3A is a detailed flowchart of the method of the present invention whereby a questionnaire is generated by establishing the questionnaire's parameters and its associated data fields before deployment via internet or other communication means to a respondent user.

FIG. 3B is a continuation of the detailed flowchart of the method of the present invention whereby a questionnaire is generated, deployment, utilized and the resulting data generation captured.

FIG. 3C is a continuation of the detailed flowchart of the method of the present invention whereby a questionnaire is generated, deployment, utilized and the resulting data generation captured.

FIG. 3D is a continuation of the detailed flowchart of the method of the present invention whereby a questionnaire is generated, deployment, utilized and the resulting data generation captured.

FIG. 4 is a flowchart of the representative branch logic flow from each of the “yes/no” type questions utilized within the questionnaire.

FIG. 5 is a flowchart of the representative logic flow from each of the “multiple choice” type questions utilized within the questionnaire.

FIG. 6 is a flowchart of the representative logic flow from each of the “open-ended” type questions utilized within the questionnaire.

FIG. 7 is a flowchart of the flow-down merge of data input that begins with responses from a respondent and concludes with the capture of the data in a centralized database.

FIG. 8 is a flowchart of the method for automatically extracting information from a database and then updating the appropriate data fields.

### DETAILED DESCRIPTION OF THE PREFERRED EMBODIMENTS

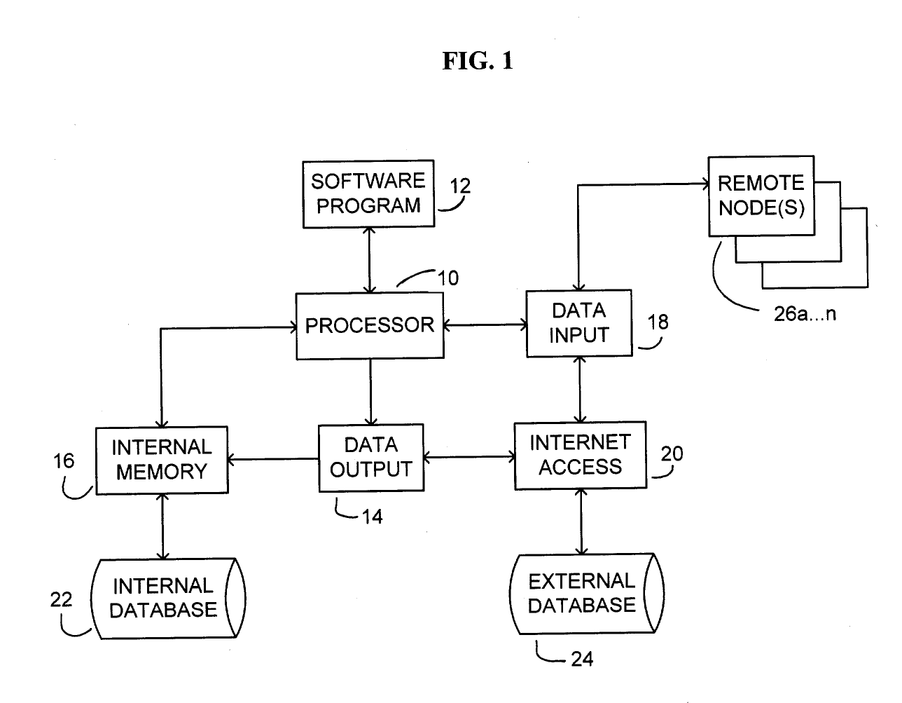

Beginning with FIG. 1, there is shown a diagram of the system of the present invention showing the interoperable relationship of each of the high-level components of the system. A system user, who in the preferred embodiment, desires to create a questionnaire for market research purposes accesses the system through a personal computer (PC) or similar computing device. It should be noted, however, that both the system and the method of the present invention are particularly well suited for creating general questionnaires that can be deployed for testing purposes (academic or otherwise) or simply for database building or general research.

The data processing system has a processor 10 that is interoperably linked to a software program 12, though it is contemplated that the processor 10 may be linked to more than one program, the importance of software program 12 lies in its ability to generate an integrated research program. The program, and its resulting questionnaire generation, is built by a system user by responding to a series of prompts that allow the system user to select individual questions, import data, or customize reporting based on the eventual results recorded from respondents to the questionnaire. The processor 10 will handle data being channeled to it by data input 18 which may be a keyboard input, a scanner input, a link from one or more remote nodes 26a through 26n, or input from an internet access point 20. Internet access point 20 can, in turn, be in communication with an external database 24.

In addition to process data inputs, the processor 10 can also output data 14 that in turn can be used to populate questionnaire fields or support external report generation. Data output 14 can also be uploaded through the internet access to support various external requirements. Processor 10 can also cause data to be stored internally 16 for later use or for use in populating internal database fields 22.

The underlying program generates the “smart questionnaire” with its logical skips, etc. It can then be either posted on the internet; or, installed on interviewer's PC/terminals, including network versions (i.e., as they call a respondent to conduct an interview they type/select the unique responses and as a function of each response the software will take the interviewer to a specific logical path; or, the questionnaire an be put on a diskette and sent to participants; or, a paper questionnaire can be generated (filled in by an interviewer over the phone). All the input is then collected and merged to create an integrated report.

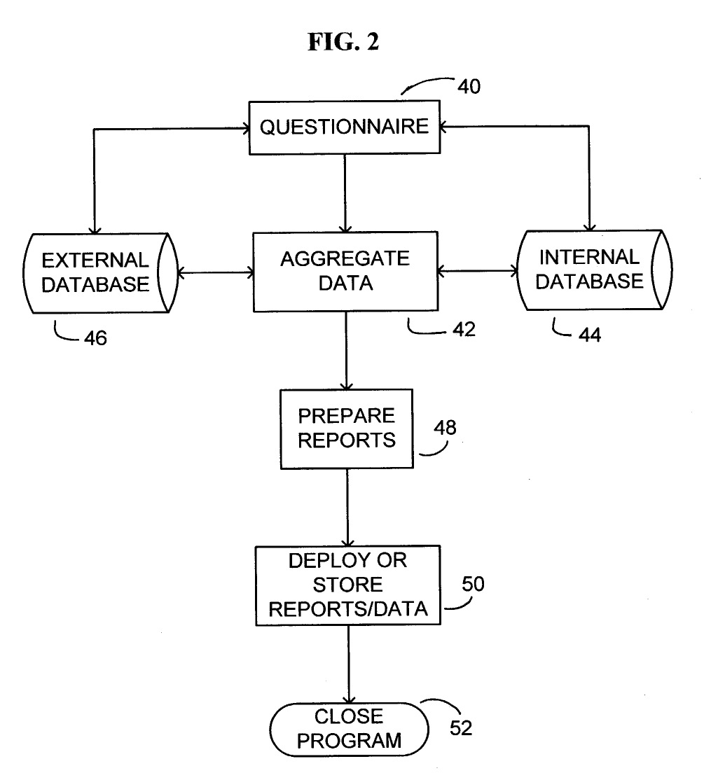

Turning then to FIG. 2, there is shown a diagram of the program relationships for each of the high-level routines and data sources for the research program generating system of the present invention.

The research program 40 will utilize its individual questions to elicit responses utilized to build the aggregate data 42 and to supply data for specific fields within internal database 44. The aggregate data 42, in turn, will interact with the internal database 44 to both give and receive data as required to formulate reports for both internal and external requirements.

The aggregate data 42 will output or merge data to the internal database 44 for use in preparing reports as well as outputting or merging data to an external database 46. The external database 46 will utilize the data received from the aggregate data 42 and the data received from the questionnaire 40 to form data structures to be utilized for external report formulation or for use by the aggregate data 42. This reduces the burden on the respondent to answer questions where the data is available elsewhere.

Data structures formed from the aggregation of data 42 are utilized to prepare reports 48 that can be utilized internally or for external report generation. Reports and data are stored or deployed at 50 before the program is closed at 52.

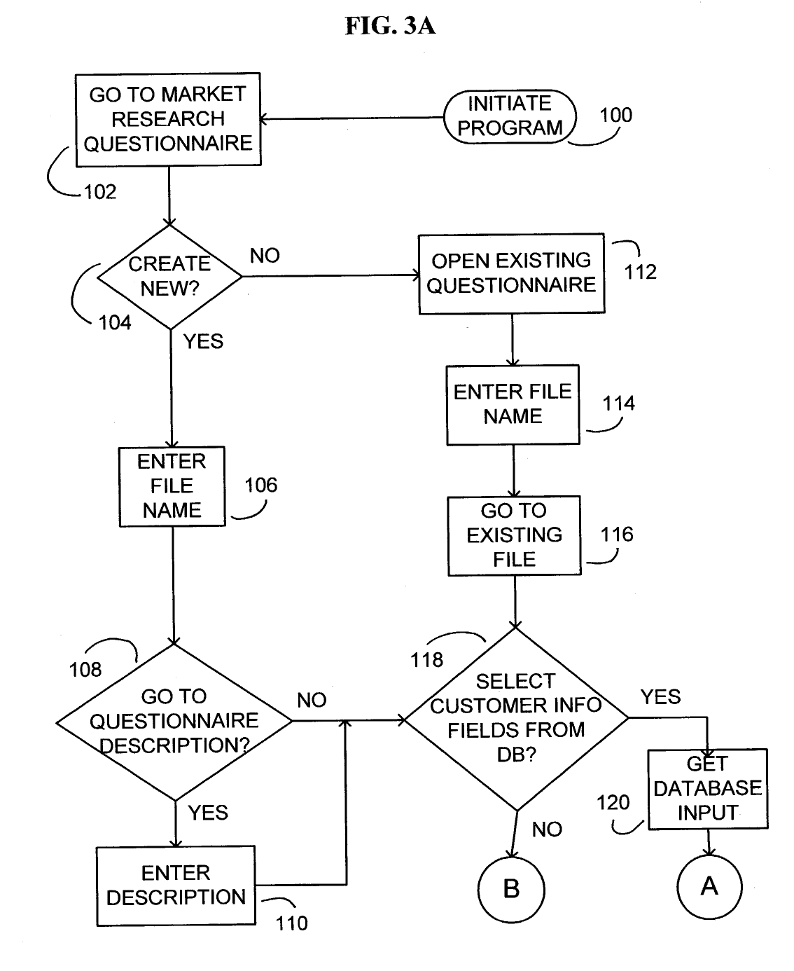

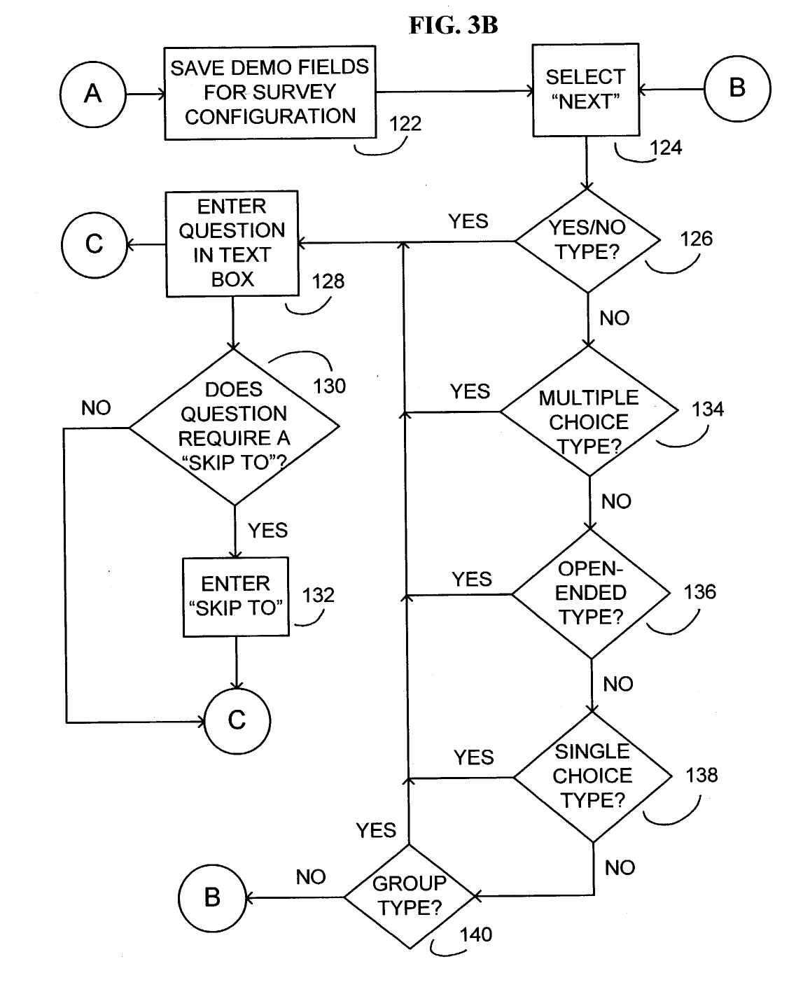

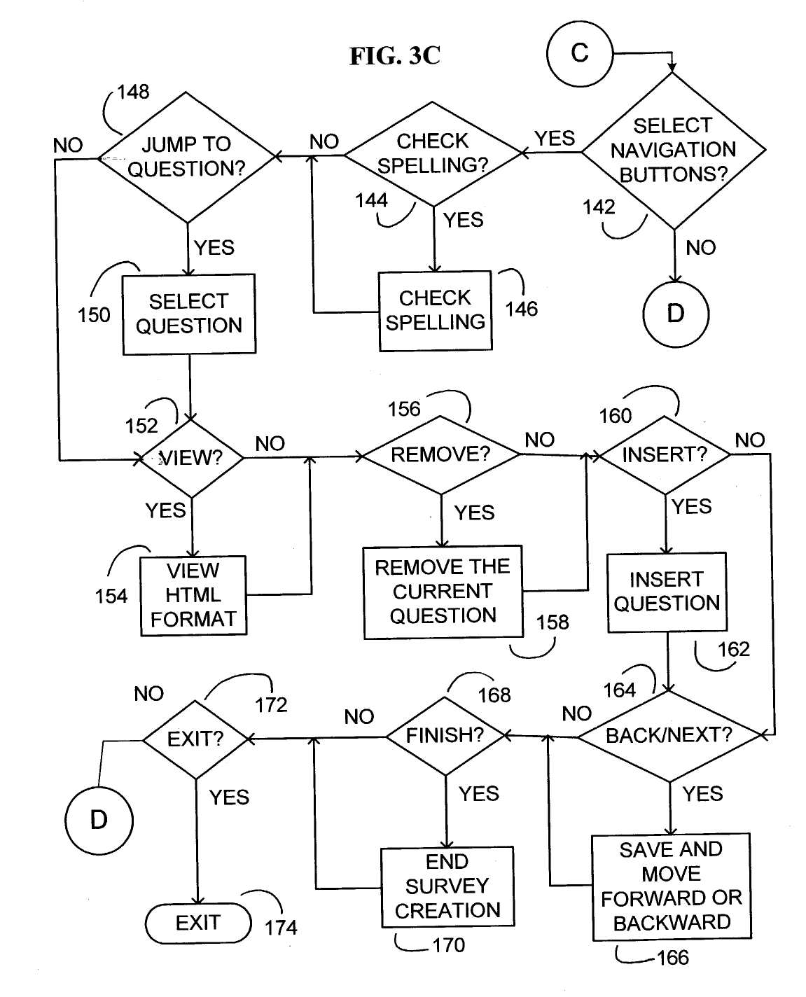

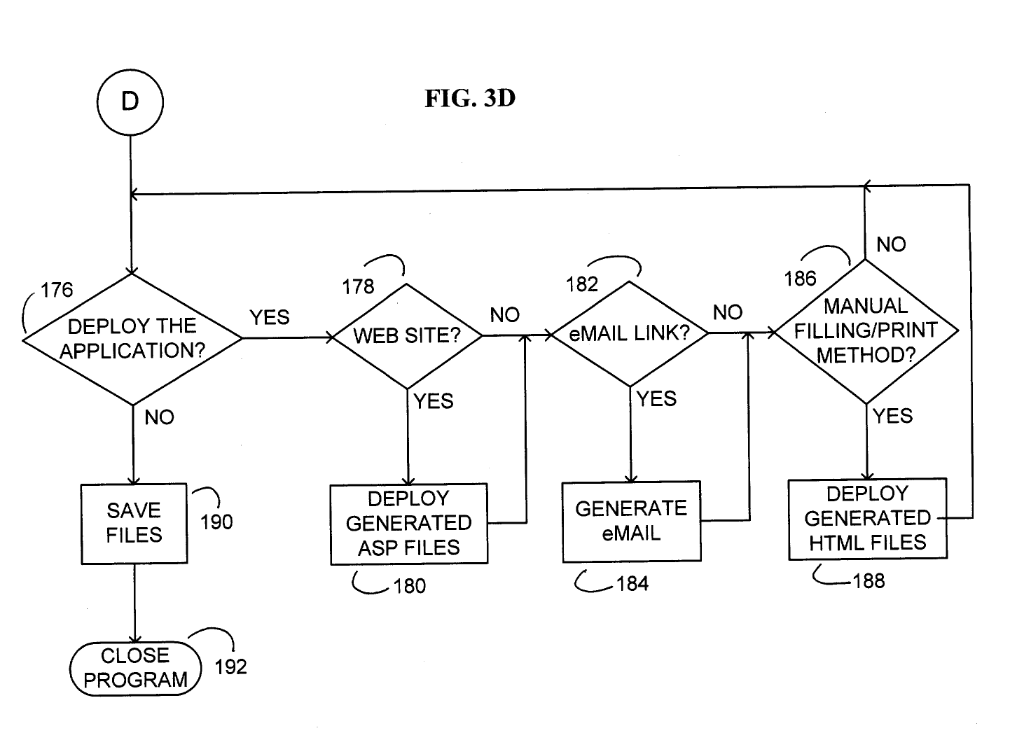

Turning to FIG. 3A there is shown a detailed flowchart of the method of the present invention whereby a questionnaire is generated by establishing the questionnaire's parameters and its associated data fields before deployment via internet or other communication means to a respondent user. The method flow begins with system initiation at step 100 and the method then advances from step 100 to step 102 where a market research questionnaire (MRQ) screen is displayed to the system user. At this point, the system user is the user who is designing the questionnaire for the purpose of eliciting information. The information is then used for market research. Alternatively, a questionnaire could be designed to test the knowledge level of a particular respondent (i.e., for testing purposes), or in another embodiment, could be used to train a database. From step 102, the method advances to the query at step 104.

The method, at step 104, queries as to whether or not a new questionnaire is to be created. If the response to the query is “YES,” then the method advances to step 106 where the file name of the new questionnaire is entered into the system supporting the invention method. The method then advances to a query at step 108. The system, through the medium of the MRQ screen, will ask at step 108 if the system user wants to enter up to three lines of description to be associated with the new questionnaire. The descriptive information will be displayed at the top of the questionnaire that the respondent will see. The system user may enter descriptive text or other information. The use of three lines of description is a design choice and it is contemplated that the questionnaire description could be more or less detailed depending upon the needs of the system user. If the response to the query at step 108 is “YES,” then the method advances to step 110 where the description input occurs before re-entering the system flow between steps 108 and 118. If the response to the query at step 108 is “NO,” however, then the method advances directly to the query at step 118.

Returning to step 104, if the response to the query “CREATE NEW?” is “NO,” then the method advances to step 112 where the decision to open a pre-existing questionnaire is made and the questionnaire file selected by “clicking” on the desired file as presented in a list at step 114. The method advances, at step 116, to the pre-existing questionnaire and then queries at step 118 as to whether or not customer data or associated demographic data is to be selected from a database. The program will import demographic data from a database such as that available from the MICROSOFT® ACCESS™ routines that are commercially available. The demographic data might include information such as: the respondent's name; age; organization name; department name; organization address; and, the size of the respondent pool. If the data to be applied is from a previous respondent, then the respondent's e-mail address (for web based distribution). The fields of demographic information will be displayed in the questionnaire before the first question. It is possible to select fields of information (document purpose, environment, etc.) to display at the top of the questionnaire.

Returning to the query at step 118, if the response to the query is “YES,” then the method advances to step 120 where the program gets the data input from the selected database before advancing along path A to step 122 as found in FIG. 3B. If, however, the response to the query at step 118 is “NO,” then the method advances along path B to step 122 as found in FIG. 3B.

The method advances along paths A and B to FIG. 3B which is a continuation of the detailed flowchart of the method of the present invention whereby a questionnaire is generated, deployed, utilized and the resulting data generation captured. Path A enters FIG. 3B at step 122 where any chosen demographic fields are saved for use in configuring the questionnaire. The method then advances from step 122 to step 124. Additionally, path B enters FIG. 3B at step 124. At step 124, the system user selects “NEXT” and is presented with a screen that allows the first question of the questionnaire to be entered.

There are a number of different question types that can be utilized in building the questionnaire; some of format driven examples of this type are: the yes/no question; the multiple-choice question; the open-ended question; the single choice question; and, the group-type question. The question types can be utilized in any order, or in any combination.

The system method advances to a query at step 126 that asks if the user wants to employ a “yes/no” type question; that is, the set of answers to the particular question are limited to either a “Yes” or a “No” answer. If the response to the query is “YES,” then the method advances to step 128 where the question is entered into the box on the displayed screen of the program. From step 128, the system user advances to two further queries essentially simultaneously. First, the path C is always available to the system user while utilizing the question entry screen of the program. Path C advances to a query at step 142 as is found in FIG. 3C. Secondly, the system user advances from step 128 to the further query at step 130. At step 130, the method queries as to whether or not the question entered requires a “Skip To” path. If the response is “YES,” then the method advances to step 132 where if the respondent's answers require the question logic flow to skip to another question, then that question number can be entered in the “Skip To” box; the method then proceeds along path C to a query at step 142 as is found in FIG. 3C. If the response to the query at step 130 is “NO,” however, then the method advances directly to path C.

Returning to the query at step 126, if the response to the query is “NO,” then the method advances to the query at step 134 that asks if the user wants to employ a “multiple/choice” type question; that is, there is a multiple choice of specific answers to the particular question to be asked. If the response to the query is “YES,” then the method advances to step 128 where the question is entered into the box on the displayed screen of the program. From step 128, the system user advances to two further queries essentially simultaneously. First, the path C is always available to the system user while utilizing the question entry screen of the program. Path C advances to a query at step 142 as is found in FIG. 3C. Secondly, the system user advances from step 128 to the further query at step 130. At step 130, the method queries as to whether or not the question entered requires a “Skip To” path. If the response is “YES,” then the method advances to step 132 where if to the respondent's answers require the question logic flow to skip to another question, then that question number can be entered in the “Skip To” box; the method then proceeds along path C to a query at step 142 as is found in FIG. 3C. If the response to the query at step 130 is “NO,” however, then the method advances directly to path C.

Returning to the query at step 134, if the response to the query is “NO,” then the method advances to the query at step 136 that asks if the user wants to employ an “open-ended” type question; that is, there is no specific answer to the particular question to be asked. For this question type, the response will be parsed and a weighting formula applied to determine how certain data will be used. If the response to the query is “YES,” then the method advances to step 128 where the question is entered into the box on the displayed screen of the program. From step 128, the system user advances to two further queries essentially simultaneously. First, the path C is always available to the system user while utilizing the question entry screen of the program. Path C advances to a query at step 142 as is found in FIG. 3C. Secondly, the system user advances from step 128 to the further query at step 130. At step 130, the method queries as to whether or not the question entered requires a “Skip To” path. If the response is “YES,” then the method advances to step 132 where if the respondent's answers require the question logic flow to skip to another question, then that question number can be entered in the “Skip To” box; the method then proceeds along path C to a query at step 142 as is found in FIG. 3C. If the response to the query at step 130 is “NO,” however, then the method advances directly to path C.

Returning to the query at step 136, if the response to the query is “NO,” then the method advances to the query at step 138 that asks if the user wants to employ a “single choice” type question; that is, there is a single choice of a set of answers that can had from among a field of choices. Typically, this is established as a selection from among a set that ranges from “Strongly Agree” to Strongly Disagree” or some similar range response. If the response to the query is “YES,” then the method advances to step 128 where the question is entered into the box on the displayed screen of the program.

From step 128, the system user advances to two further queries essentially simultaneously. First, the path C is always available to the system user while utilizing the question entry screen of the program. Path C advances to a query at step 142 as is found in FIG. 3C. Secondly, the system user advances from step 128 to the further query at step 130. At step 130, the method queries as to whether or not the question entered requires a “Skip To” path. If the response is “YES,” then the method advances to step 132 where if the respondent's answers require the question logic flow to skip to another question, then that question number can be entered in the “Skip To” box; the method then proceeds along path C to a query at step 142 as is found in FIG. 3C. If the response to the query at step 130 is “NO,” however, then the method advances directly to path C.

Returning to the query at step 138, if the response to the query is “NO,” then the method advances to the query at step 140 that asks if the user wants to employ a “group-type” question; that is, the group-type question allows the system user to ask a series of questions based upon one general question. The following format serves as an example:

Extremely Somewhat Neutral Somewhat Not At All

Important Important Unimportant Important

Size

Reliability

Cost

If the response to the query at step 140 is “YES,” then the method advances to step 128 where the question is entered into the box on the displayed screen of the program. From step 128, the system user advances to two further queries essentially simultaneously. First, the path C is always available to the system user while utilizing the question entry screen of the program. Path C advances to a query at step 142 as is found in FIG. 3C. Secondly, the system user advances from step 128 to the further query at step 130. At step 130, the method queries as to whether or not the question entered requires a “Skip To” path. If the response is “YES,” then the method advances to step 132 where if the respondent's answers require the question logic flow to skip to another question, then that question number can be entered in the “Skip To” box; the method then proceeds along path C to a query at step 142 as is found in FIG. 3C. If the response to the query at step 130 is “NO,” however, then the method advances directly to path C.

Returning to the query at step 140, if the response to the query is “NO,” then the method advances along path B to re-enter the method flow at step 124.

Path C flows into FIG. 3C which is a continuation of the detailed flowchart of the method of the present invention whereby a questionnaire is generated, deployed, utilized and the resulting data generation captured. Path C enters the flow at the query at step 142 that asks whether or not the “Select Navigation” features are to be employed. The “Select Navigation” features are found on the question screen and can be utilized in any order, though they are represented here in a particular order only for ease of explanation and to demonstrate the logic flow of the system user.

If the response to the query at step 142 is “NO,” then the method advances along path D to re-enter the method flow at the query at step 176 as is shown in FIG. 3D. However, if the response to the query is “YES,” then the method advances to the further query at step 144. At step 144, the method queries as to whether or not spelling of the entered data is to be checked. If the response to the query is “YES,” then the method advances to step 146 and performs a spell-check routine prior to advancing to the query at step 148. Otherwise, if the response to the query at step 144 is “NO,” then the method advances directly to the query at step 148. At step 148, the method queries as to whether or not the system operator wants to jump to a particular question from the question entered in the screen field. If the response to the query is “YES,” then the method advances to step 150 and the system operator selects a question number to jump to prior to advancing to the query at step 152. Otherwise, if the response to the query at step 148 is “NO,” then the method advances directly to the query at step 152.

Step 148 queries as to whether or not the system operator wants to view an HTML format of the questionnaire under construction. This selection opens a window on the screen so that the system operator can view the questionnaire. If the response to the query is “YES,” then the method advances to step 154 and the system operator can view the questionnaire prior to advancing to the query at step 156. Otherwise, if the response to the query at step 152 is “NO,” then the method advances directly to the query at step 156. At step 156, the method queries as to whether or not the system operator wants to remove the current question from the screen field. If the response to the query is “YES,” then the method advances to step 158 and the system operator can remove the question from the screen field prior to advancing to the query at step 160. Otherwise, if the response to the query at step 156 is “NO,” then the method advances directly to the query at step 160.

Step 160 queries as to whether or not the system operator wants to insert a question before the currently displayed. If the response to the query is “YES,” then the method advances to step 162 and the system operator can insert a question in the questionnaire prior to advancing to the query at step 164. Otherwise, if the response to the query at step 152 is “NO,” then the method advances directly to the query at step 164. At step 164, the method queries as to whether or not the system operator wants to select to save the file and move forward or backward one question at a time. If the response to the query is “YES,” then the method advances to step 166 and the system operator can select back or next depending on whether or not the desire is to back one place or move forward one place prior to advancing to the query at step 168. Otherwise, if the response to the query at step 164 is “NO,” then the method advances directly to the query at step 168.

Step 168 queries as to whether or not the system operator is finished with the creation of the questionnaire. This selection will allow the system operator to end the survey creation and to exit the program while creating necessary ASP files to enable deployment. If the response to the query is “YES,” then the method advances to step 170 and the system operator can end the creation of the questionnaire prior to advancing to the query at step 172. Otherwise, if the response to the query at step 168 is “NO,” then the method advances directly to the query at step 172. At step 172, the method queries as to whether or not the system operator is prepared to exit the program. If the response to the query is “YES,” then the method advances to step 174 and the system operator can exit the routine. Otherwise, if the response to the query at step 172 is “NO,” then the method advances to path D to re-enter the method flow at the query at step 176 as is shown in FIG. 3D.

FIG. 3D is a continuation of the detailed flowchart of the method of the present invention whereby a questionnaire is generated, deployed, utilized and the resulting data generation captured. Path D re-enters the method flow at the query at step 176 that asks whether or not the system user would like to deploy the application. The application can be deployed using three different methods. If the response to the query is “NO,” then the created questionnaire files are saved at step 190 for future deployment or other use before closing out the program and exiting at step 192.

Deployment occurs with a “YES,” response to the query at step 176. The method then advances to the query at step 178 that asks if the system user wants to utilize a communications link. The program generates ASP files that can be deployed directly on a web site on an internet or an extranet. If the response to the query is “YES,” then the program will deploy the questionnaire using generated ASP files; otherwise, if the response to the query at step 178 is “NO,” then the method will advance to step 182 and query as to whether or not deployment should take place via an e-mail link. Links to the questionnaire web site can be sent via e-mail to intended respondents or others. If the system user elects to send the questionnaire via an e-mail link then the method advances to step 184 to deploy before moving to step 186; otherwise, the method advances directly to the query at step 186.

At step 186, the method queries as to whether or not the deployment shall occur through a manual filling/print method wherein the program generates an HTML file which can be printed and filled in manually by the system user. If the response to the query is “YES,” then the questionnaire is deployed at step 188 through generation of the HTML files. If the response to the query at step 186 is “NO,” then the method returns re-enter the flow path at step 176.

Deployment of the questionnaire and/or its data is a driving factor in report generation. Data is aggregated in a system users database of choice. If available data exists already with respect to the respondents to whom the market surveys are to be sent, the program will provide consolidation of the data (or a subset thereof) as specified by the system user with the data that is to collected via the surveys.

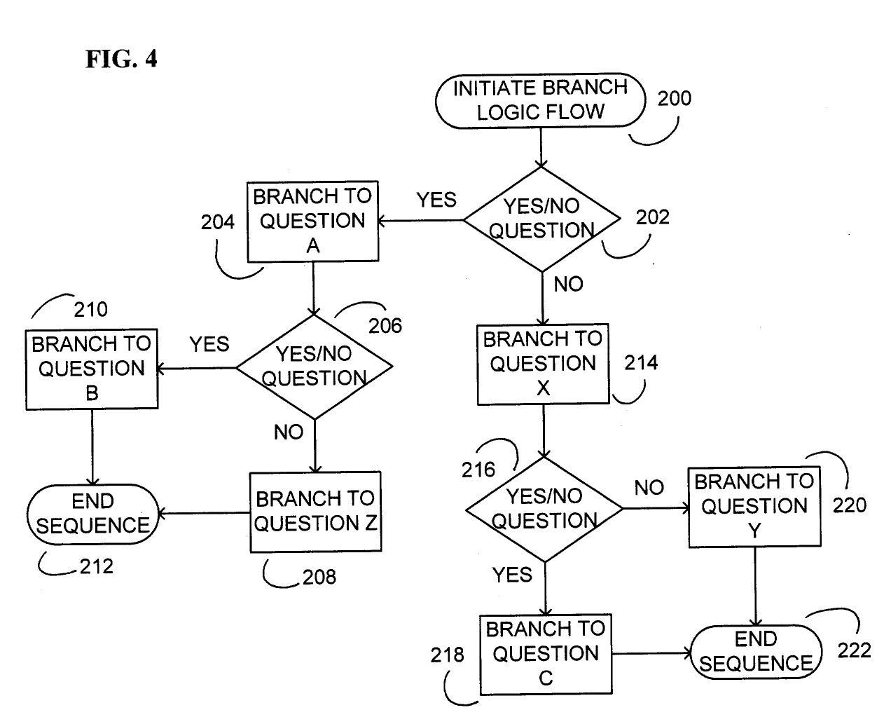

Turning to FIG. 4 there is shown a flowchart of the representative branch logic flow from each of the “yes/no” type questions utilized within the questionnaire. The logic flow begins at step 200 where the sequence is initiated. The method advances to the posing of a “yes/no” question as is shown at step 202. If the response would draw a “YES” from the respondent, then the logic path indicates a branch to question “A” at step 204; the next “yes/no” question is then posed at step 206. If the response would draw a “YES” from the respondent, then the logic path indicates a branch to question “B” at step 210 before ending the sequence at step 212. If the response to the query at step 206, is “NO,” then the logic path indicates a branch to question “Z” at step 208 before ending the sequence at step 212.

Returning to step 202, if the response to the query at step 202, is “NO,” then the logic path indicates a branch to question “X” at step 214. The next “yes/no” question is then posed at step 216. If the response would draw a “YES” from the respondent, then the logic path indicates a branch to question “C” at step 218 before ending the sequence at step 222. If the response to the query at step 216, is “NO,” then the logic path indicates a branch to question “Y” at step 220 before ending the sequence at step 222.

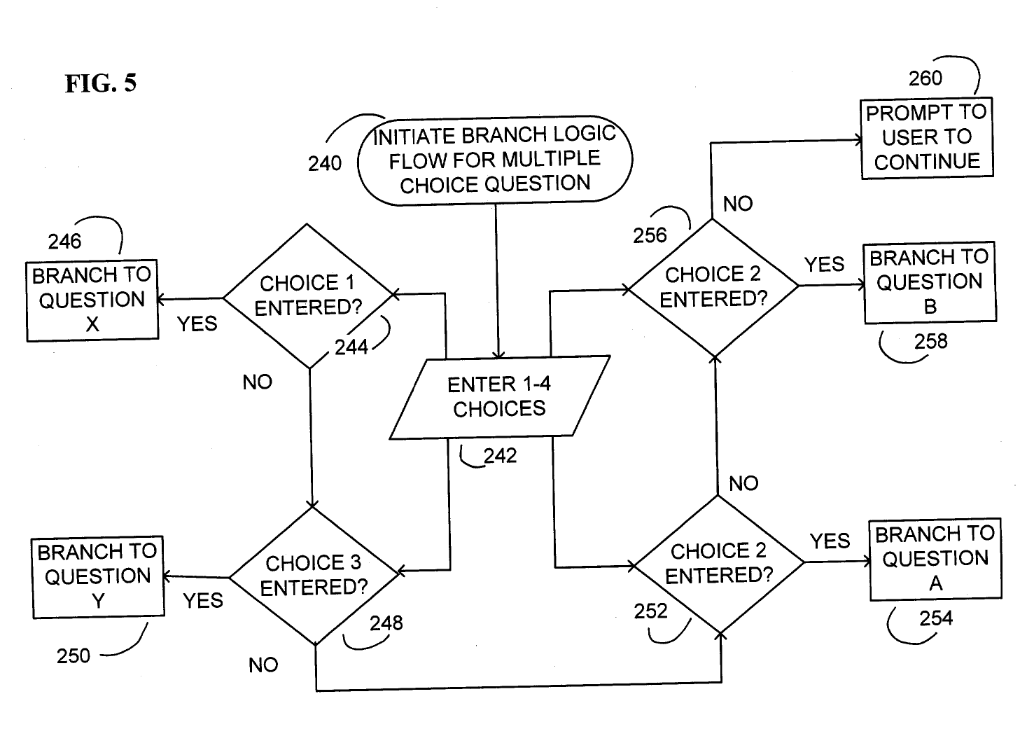

Turning to FIG. 5 there is shown a flowchart of the representative logic flow from each of the “multiple choice” type questions utilized within the questionnaire. The logic flow begins at step 240 where the sequence is initiated. The method then advances to step 242 where one of choices one through four is entered. If choice one is entered, the method advances to the posing of a “yes/no” question as is shown at step 244. If the response would draw a “YES” from the respondent, then the logic path indicates a branch to question “X” at step 246. If the response to the query at step 244, is “NO,” then the logic path indicates a branch to the next query posed at step 248. If the response at step 248 would draw a “YES” from the respondent, then the logic path indicates a branch to question “Y” at step 250.

If the response to the query at step 248, is “NO,” then the logic path indicates a branch to the next query posed at step 252. If the response at step 252 would draw a “YES” from the respondent, then the logic path indicates a branch to question “A” at step 254. If the response to the query at step 252, is “NO,” then the logic path indicates a branch to the next query posed at step 256. If the response at step 256 would draw a “YES” from the respondent, then the logic path indicates a branch to question “B” at step 258. If the response to the query at step 256, is “NO,” then the logic path indicates a branch to a user prompt at step 260 which prompts the user to continue by making a selection or an exit choice.

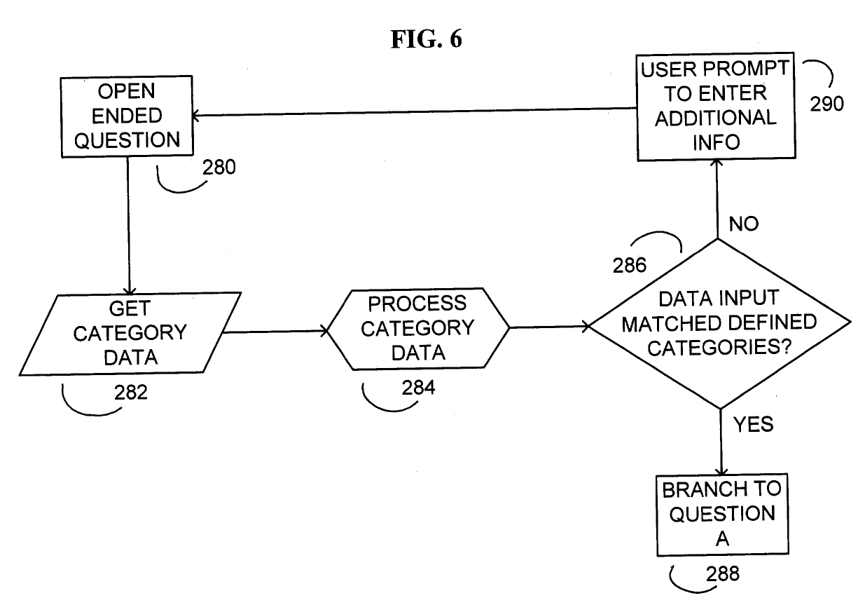

FIG. 6 is a flowchart of the representative logic flow from each of the “open-ended” type questions utilized within the questionnaire.

In this logic flow, the open-ended question is established at step 280 where the system user is asked to enter the number of categories desired for each open question and to assign a name to each category. From step 280, the logic flow advances on to step 282 where category data is obtained; the category data is processed at step 284 and then subjected to a query at step 286. At step 286, the method queries as to whether or not the data input by the respondent matches the categories as defined by the system user. If a match occurs within the tolerances set by the system user, then the method advances to step 288 and branches to another question as determined by the category. On the other hand, if the response to the query at step 286 is “NO,” then the method advances to step 290 where the user is prompted to enter additional info, thus redefining the open-ended question and proceeding back to step 280. A conditional logic is available for open-ended questions to allow for a skip pattern when applicable.

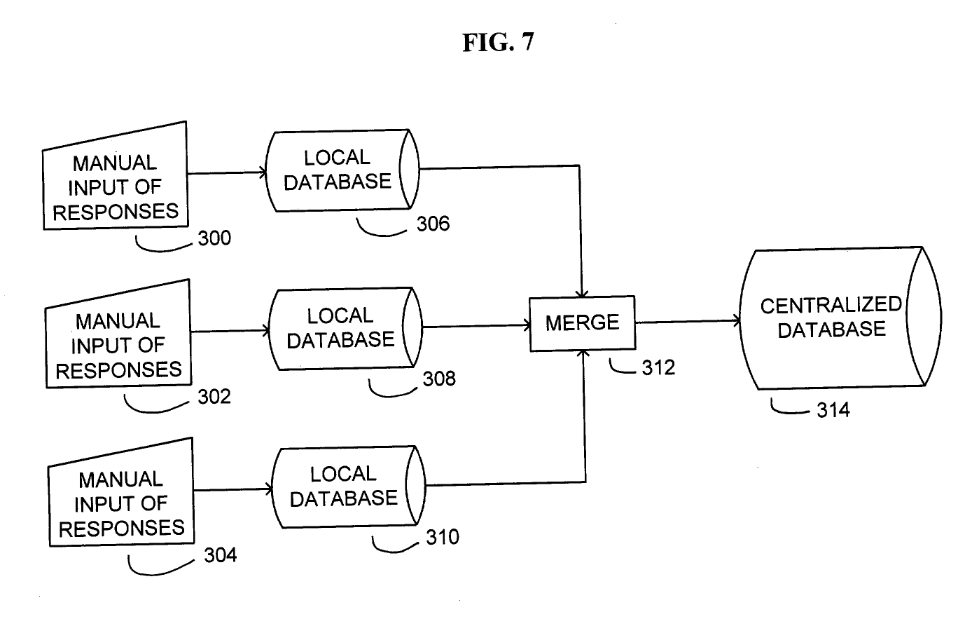

Turning to FIG. 7 there is shown a flowchart of the flow-down merge of data input that begins with responses from a respondent and concludes with the capture of the data in a centralized database. The manual input of responses to the established questionnaire is completed as based upon the method of questionnaire deployment. If the input is performed by multiple respondents designated as entry points 300, 302, and 304, then these responses can be captured directly in a central database or can be captured individually at corresponding local databases 306, 308, and 310 respectively. The database files are merged at a centralized gathering routine 312 before being consolidated at the centralized database 314.

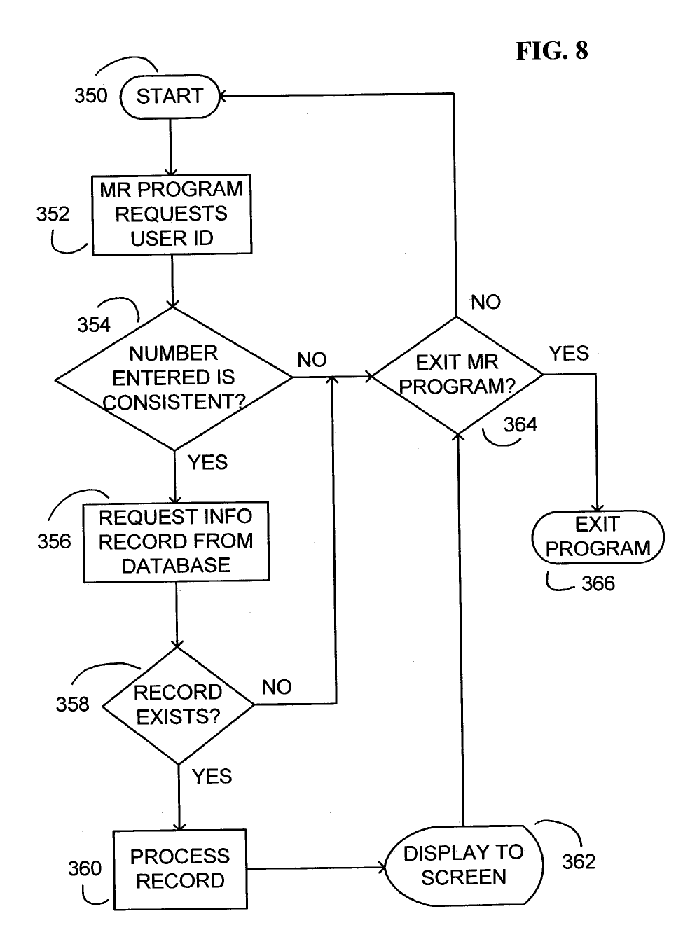

FIG. 8 is a flowchart of the method for automatically extracting information from a database and then updating the appropriate data fields. The method initiates the routine at step 350 before advancing to step 352 where the program requests a user identification number (USID). The USID entered is checked, at step 354, for consistency based on a user profile. If the response to the query concerning the consistency of the USID is “NO,” then the method advances to the query at step 364; otherwise, the method advances to step 356 where the information record is requested from the database. The method queries, at step 358, as to whether or not the information record exists. If the response to the query is “NO,” then the method advances on to the query at step 364. However, if the response to the query at step 358 is “YES,” then the system processes the record at step 360 and displays it to the system user at step 362 before advancing to the query at step 364.

At step 364, the method queries as to whether or not the system user wants to exist the program. If the response is “YES,” then the method advances to step 366 and the program is exited. If the response to the query at step 364 is “NO,” however, then the method returns to step 350.

While certain embodiments have been described above in terms of the system within which the questionnaire generation and utilization may occur and/or reside, the invention is not limited to such context. The system shown in FIG. 1 is one example of a host system for the invention, and the system elements are intended merely to exemplify the type of peripherals and software components that can be used in support of the invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method of generating and deploying a market research questionnaire in a data processing system, comprising the steps of:
(a) initiating a generation program for generating said market research questionnaire by defining said market research questionnaire;
(b) linking said data processing system with a database;
(c) importing a subset of data from said database to said generation program so that one or more data fields of said market research questionnaire are populated by said subset of data;
(d) entering a set of questions and a set of answer choices into said one or more data fields of said market research questionnaire;
(e) selecting a navigation path for said generation program; and
(f) deploying said market research questionnaire.

2. The method of claim 1, wherein said defining step further comprises the step of assigning a file name for said market research questionnaire.

3. The method of claim 1, wherein said defining step further comprises the step of assigning a description for said market research questionnaire.

4. The method of claim 1, wherein said database is remote to said data processing system.

5. The method of claim 1, wherein said database is co-located with said data processing system.

6. The method of claim 1, wherein said subset of data further comprises demographic data relative to a particular respondent of said questionnaire.

7. The method of claim 1, wherein said subset of data further comprises data demographic data relative to a group of one or more respondents of said questionnaire.

8. The method of claim 1, wherein said deploying step further comprises generating ASP files within said generation program.

9. The method of claim 1, wherein said deploying step further comprises establishing an e-mail link from said questionnaire through said generation program.

10. The method of claim 1, wherein said deploying step further comprises establishing an e-mail link from said generation program.

11. The method of claim 1, wherein said deploying step further comprises establishing an e-mail link from one or more reports generated by said generation program.

12. The method of claim 1, further comprising the step of allowing said one or more respondents to answer each of said one or more questions on said questionnaire; and

13. The method of claim 12, further comprising the step of storing data representative of said answer from each one of said one or more respondents with respect to each of said one or more questions in said questionnaire.

14. The method of claim 13, further comprising reporting means for producing one or more reports representative of said data representative of said answer from each one of said one or more respondents.

15. The method of claim 11, wherein said one or more reports can be transmitted to a remote location.

16. The method of claim 14, wherein said one or more reports can be transmitted to a remote location.

17. The method of claim 11, wherein said one or more reports can be printed locally to said system.

18. The method of claim 14, wherein said one or more reports can be printed locally to said system.

19. The method of claim 1, wherein said set of questions are further comprised of at least one question capable of being answered with a “yes” or “no” response.

20. The method of claim 1, wherein said set of questions are further comprised of at least one question of a multiple-choice type wherein a response to said multiple-choice question is chosen from a plurality of possible responses.

21. The method of claim 1, wherein said set of questions are further comprised of at least one question of an open-ended type wherein a response to said open-ended question is compared to a field of possible responses to determine whether or not said response to said open-ended question is to be categorized.

22. A system for generating and deploying a market research tool, comprising:
(a) a data processing system;
(b) a questionnaire generating program capable of being run on said data processing system and for creating a questionnaire wherein said questionnaire further comprises one or more questions to answered by a one or more respondents;
(c) first data storage means, for storing data wherein said data can be downloaded to said questionnaire generating program by request from said questionnaire generating program;
(d) data input means for inputting data to said questionnaire generating program in response to queries from said questionnaire generating program and wherein said data input is utilized to create said questionnaire;
(e) deployment means for deploying said questionnaire to said one or more respondents;
(f) response means for allowing said one or more respondents to answer each of said one or more questions on said questionnaire; and
(g) second data storage means for storing data representative of said answer from each one of said one or more respondents with respect to each of said one or more questions in said questionnaire.

23. The system of claim 22, further comprising reporting means for producing one or more reports representative of said data representative of said answer from each one of said one or more respondents.

24. The system of claim 22, wherein said one or more reports can be transmitted to a remote location.

25. The system of claim 22, wherein said one or more reports can be printed locally to said system.

26. The system of claim 22, wherein said one or more questions are further comprised of at least one question capable of being answered with a “yes” or “no” response.

27. The system of claim 22, wherein said set of questions are further comprised of at least one question of a multiple-choice type wherein a response to said multiple-choice question is chosen from a plurality of possible responses.

28. The system of claim 22, wherein said set of questions are further comprised of at least one question of an open-ended type wherein a response to said open-ended question is compared to a field of possible responses to determine whether or not said response to said open-ended question is to be categorized.

29. A method of accumulating and reporting on data through deployment of a questionnaire, said accumulation occurring in a data processing system, said method comprising the steps of:
(a) creating said questionnaire through entry of a set of questions into a questionnaire generating program residing in said data processing system;
(b) supplementing one or more data fields within said questionnaire by linking said questionnaire with one or more database inputs;
(c) selecting means within said data processing system for deploying said questionnaire to one or more respondents;
(d) receiving responses relevant to said questionnaire from said one or more respondents;
(e) merging data received at a centralized database; and
(f) reporting on said received data through a reporting routine of said data processing system.

30. The method of claim 29, wherein said one or more questions are further comprised of at least one question capable of being answered with a “yes” or “no” response.

31. The method of claim 29, wherein said set of questions are further comprised of at least one question of a multiple-choice type wherein a response to said multiple-choice question is chosen from a plurality of possible responses.

32. The system of claim 29, wherein said set of questions are further comprised of at least one question of an open-ended type wherein a response to said open-ended question is compared to a field of possible responses to determine whether or not said response to said open-ended question is to be categorized.
